(19) United States
(12) Patent Application Publication
(10) Pub. No.: US 2025/0335230 A1
(43) Pub. Date: Oct. 30, 2025

(54) REINFORCEMENT LEARNING-BASED MOVEMENT OF CONTAINERS USING CONTAINER POWER CONSUMPTION INFORMATION

(71) Applicant: Dell Products L.P., Round Rock, TX (US)

(72) Inventors: Sandra Georgy, Cairo (EG); Khalifa Abdelaziz, Cairo (EG); Nayer Riad, New Cairo (EG); John Emil Kamel Gaied Ghaly, Cairo (EG); Sherif Alaa Eldin Hussein Fawzy Awadallah, New Cairo (EG)

(21) Appl. No.: 18/648,973

(22) Filed: Apr. 29, 2024

(51) Int. Cl. G06F 9/455

(52) U.S. Cl. CPC G06F 9/45558

(57) ABSTRACT

Techniques are provided for reinforcement learning (RL)-based movement of containers based on power consumption. One method comprises obtaining information characterizing a power consumption of containers of a cluster of a containerized environment; applying the information characterizing the power consumption of the containers to a RL model that determines a reward value for moving one or more containers associated with a given node of the cluster to a different node of the cluster; and automatically controlling a movement of at least one of the containers to the different node based on the reward value. The power consumption of the containers may be determined by evaluating a resource utilization of the containers for a designated time interval. The power consumption of a given node may be determined by aggregating a power consumption of containers associated with the given node.

### BACKGROUND

Information processing systems increasingly utilize reconfigurable virtual resources to meet changing user needs in an efficient, flexible, and cost-effective manner. For example, cloud-based computing and storage systems implemented using virtual resources in the form of containers have been widely adopted. A scheduler in such containerized environments, for example, typically schedules containers to run on particular nodes of the containerized environment.

### SUMMARY

Illustrative embodiments of the disclosure provide techniques for reinforcement learning (RL)-based movement of containers using container power consumption information. An exemplary method comprises obtaining information characterizing a power consumption of respective ones of a plurality of containers of at least one cluster of a containerized environment, wherein the at least one cluster comprises a plurality of nodes; applying the information characterizing the power consumption of the respective ones of the plurality of containers to at least one RL model that determines at least one reward value for moving one or more containers associated with a given node, of the plurality of nodes, to at least one different node of the at least one cluster; and automatically controlling a movement of at least one of the one or more containers to the at least one different node based at least in part on the at least one reward value.

Illustrative embodiments can provide significant advantages relative to conventional techniques. For example, problems associated with excessive power consumption exhibited by such conventional techniques are overcome in one or more embodiments by automatically controlling a movement of one or more containers in a containerized environment based on an RL-based evaluation of container power consumption information.

These and other illustrative embodiments include, without limitation, methods, apparatus, networks, systems and processor-readable storage media.

### BRIEF DESCRIPTION OF THE DRAWINGS

FIG. 1 is a block diagram of an information processing system that provides RL-based movement of containers using container power consumption information in an illustrative embodiment;

FIG. 2 illustrates a power-aware container movement environment in an illustrative embodiment;

FIG. 3 illustrates a system for RL-based movement of containers using container power consumption information in an illustrative embodiment;

FIG. 4 illustrates a RL framework for RL-based movement of containers using container power consumption information in an illustrative embodiment;

FIG. 5 is a process diagram illustrating an application programming interface (API) server configuration process in an illustrative embodiment;

FIG. 6 is a process diagram illustrating a scheduled orchestrator job process in an illustrative embodiment;

FIG. 7 is a process diagram illustrating a power measurement process in an illustrative embodiment;

FIG. 8 illustrates a hierarchical Deep Q Networks (H-DQN) RL pod for power-aware container movement in an illustrative embodiment;

FIG. 9 is a flow diagram illustrating an exemplary implementation of a process for RL-based movement of containers using container power consumption information in an illustrative embodiment; and

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

It is often challenging to decrease power consumption (as well as carbon emissions) in cloud-based computing and/or storage systems while also ensuring that quality of service (QOS) objectives are satisfied. As noted above, a scheduler in cloud-based computing systems typically schedules containers to run on particular nodes. The scheduler determines which nodes are valid placements for each container in a scheduling queue, for example, according to applicable constraints and available resources. The scheduler then ranks each valid node and binds the pod to a suitable node. Such schedulers, however, are not typically aware of the power consumed by the containers being scheduled and thus are typically not power efficient. In one or more embodiments, the disclosed techniques for RL-based movement of containers using container power consumption information employ a scheduler that takes power consumption into account. In some embodiments, the disclosed power-aware container movement techniques schedule containers (e.g., at a designated time interval) using one or more RL models to enhance power consumption of a cluster of nodes. The scheduler may employ stop conditions to prevent infinite (e.g., excessive) container movements between different nodes. In addition, a container ignore list may be employed in some embodiments, as well as one or more container movement policies.

In one or more embodiments, the power consumption of containers within a given cluster is obtained and one or more RL models are employed to select one or more containers to move to a different node within the given cluster, as well as a destination node for each selected container with a goal of reducing power consumption.

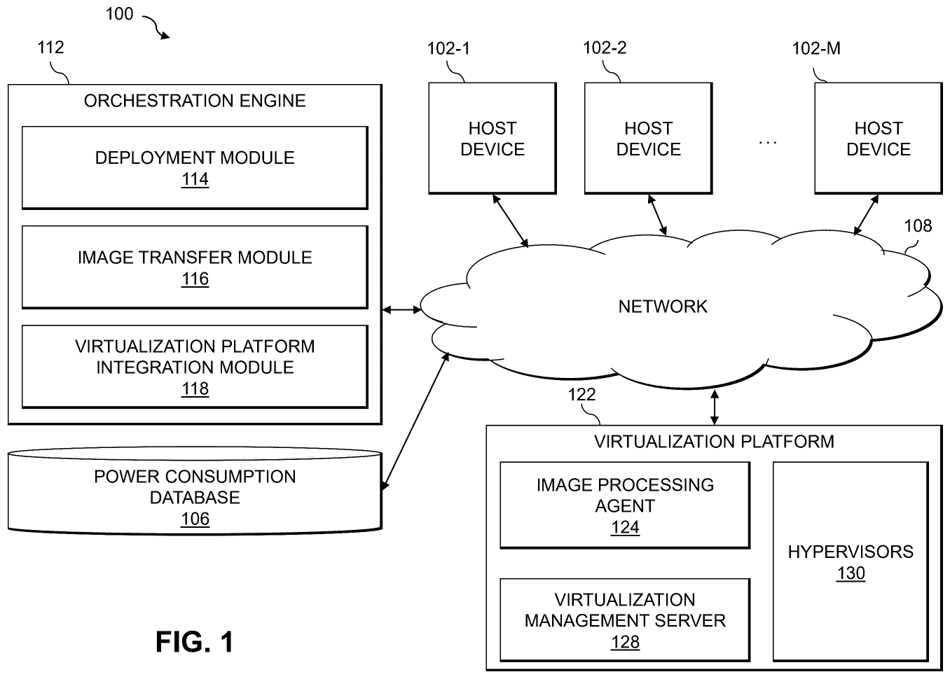

FIG. 1 shows an information processing system 100 configured in accordance with an illustrative embodiment to provide RL-based movement of containers using container power consumption information. The information processing system 100 comprises one or more host devices 102-1, 102-2, . . . 102-M (collectively, host devices 102) and an orchestration engine 112 that communicates over a network 108 with one or more virtualization platforms 122. The orchestration engine 112 may deploy one or more containerized applications to one or more of the host devices 102 and/or the virtualization platform 122.

The host devices 102, orchestration engine 112 and/or virtualization platform 122 illustratively comprise respective computers, servers or other types of processing devices capable of communicating with one another via the network 108. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, a Storage-as-a-Service (STaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be at least partially implemented outside of the cloud infrastructure context, as in the case of a stand-alone computing and storage system implemented within a given enterprise.

In the FIG. 1 embodiment, the orchestration engine 112 includes a deployment module 114, an image transfer module 116 and a virtualization platform integration module 118. The deployment module 114 is configured in some embodiments to deploy one or more virtual resources (not shown in FIG. 1). The image transfer module 116 may be configured to transfer templates of such virtual resources (e.g., virtual machines and/or containers) to and/or from the host devices 102, virtualization platform 122 and/or an image datastore. The virtualization platform integration module 118 integrates the orchestration engine 112 with the virtualization platform 122. The orchestration engine 112 may be implemented, for example, at least in part, using the Kubernetes open-source container orchestration system for automating deployment, scaling, and management of containers in one or more clusters. The orchestration engine 112 may provide a centralized management interface for monitoring and controlling the containers in a given cluster.

Images and other templates provide building blocks for container-based orchestration. Images and other templates comprise snapshots of a file system of a container that include the dependencies and configuration information needed to run a specific application or service. When a container is created from an image, for example, the container starts with the same file system as the image, allowing for consistency and predictability in the behavior of the container. Such images can be stored in a registry, such as image datastore, and can be pulled and run on any machine that has a container runtime.

At least portions of the functionality of the deployment module 114, the image transfer module 116 and/or the virtualization platform integration module 118 may be implemented at least in part in the form of software that is stored in memory and executed by a processor.

The virtualization platform 122, as shown in FIG. 1, comprises an image processing agent 124, a virtualization management server 128 and one or more hypervisors 130. The exemplary image processing agent 124 processes templates, such as obtaining one or more needed container images that are not available to the virtualization platform 122 at the time of a virtual resource deployment, and processing the obtained virtual resource templates to replicate (e.g., clone) a needed virtual resource using the template and associated deployment information. In some embodiments, the exemplary image processing agent 124 may be an agent of the orchestration engine 112. The virtualization management server 128 provides one or more functions for managing at least portions of the virtualization platform 122. In addition, the exemplary virtualization platform 122 further comprises one or more hypervisors 130 to execute one or more deployed virtual resources.

Additionally, the host devices 102, the orchestration engine 112 and/or the virtualization platform 122 can have an associated power consumption database 106 configured to store power consumption information for containers and/or nodes of the containerized environment. Power consumption database 106 in the present embodiment can be implemented using storage provided by one or more of the host devices 102 and/or a storage system (not shown in FIG. 1), or the power consumption database 106 can be accessed over the network 108. Such storage systems can comprise any of a variety of different types of storage including network-attached storage (NAS), storage area networks (SANs), direct-attached storage (DAS) and distributed DAS, as well as combinations of these and other storage types, including software-defined storage. While the power consumption database 106 is shown in FIG. 1 as a single database, the power consumption database 106 may be implemented using multiple databases, as would be apparent to a person of ordinary skill in the art.

The host devices 102, the orchestration engine 112 and/or the virtualization platform 122 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines or containers, or combinations of both as in an arrangement in which containers are configured to run on virtual machines.

The host devices 102, the orchestration engine 112 (or one or more components thereof such as the deployment module 114, image transfer module 116 and/or virtualization platform integration module 118) and the virtualization platform 122 may be implemented on respective distinct processing platforms, although numerous other arrangements are possible. For example, in some embodiments at least portions of one or more of the host devices 102, the orchestration engine 112 and the virtualization platform 122 are implemented on the same processing platform. The orchestration engine 112 and/or the virtualization platform 122 can therefore be implemented at least in part within at least one processing platform that implements at least a subset of the host devices 102.

The network 108 may be implemented using multiple networks of different types to interconnect storage system components. For example, the network 108 may comprise a portion of a global computer network such as the Internet, although other types of networks can be employed, including a wide area network (WAN), a local area network (LAN), a satellite network, a telephone or cable network, a cellular network, a wireless network such as a WiFi or WiMAX network, or various portions or combinations of these and other types of networks. The network 108 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The virtualization platform 122 in some embodiments may be implemented as part of a cloud-based system.

The host devices 102, the orchestration engine 112 and/or the virtualization platform 122 can be part of what is more generally referred to herein as a processing platform comprising one or more processing devices each comprising a processor coupled to a memory. A given such processing device may correspond to one or more containers or other types of virtualization infrastructure such as virtual machines. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The virtualization platform 122 and the orchestration engine 112 may be implemented at least in part in the first geographic location, the second geographic location, and one or more other geographic locations. Thus, it is possible in some implementations of the system 100 for different ones of the host devices 102, the orchestration engine 112, and the virtualization platform 122 to reside in different data centers.

Numerous other distributed implementations of the host devices 102, the orchestration engine 112, and/or the virtualization platform 122 are possible. Accordingly, the host devices 102, the orchestration engine 112, and/or the virtualization platform 122 can also be implemented in a distributed manner across multiple data centers.

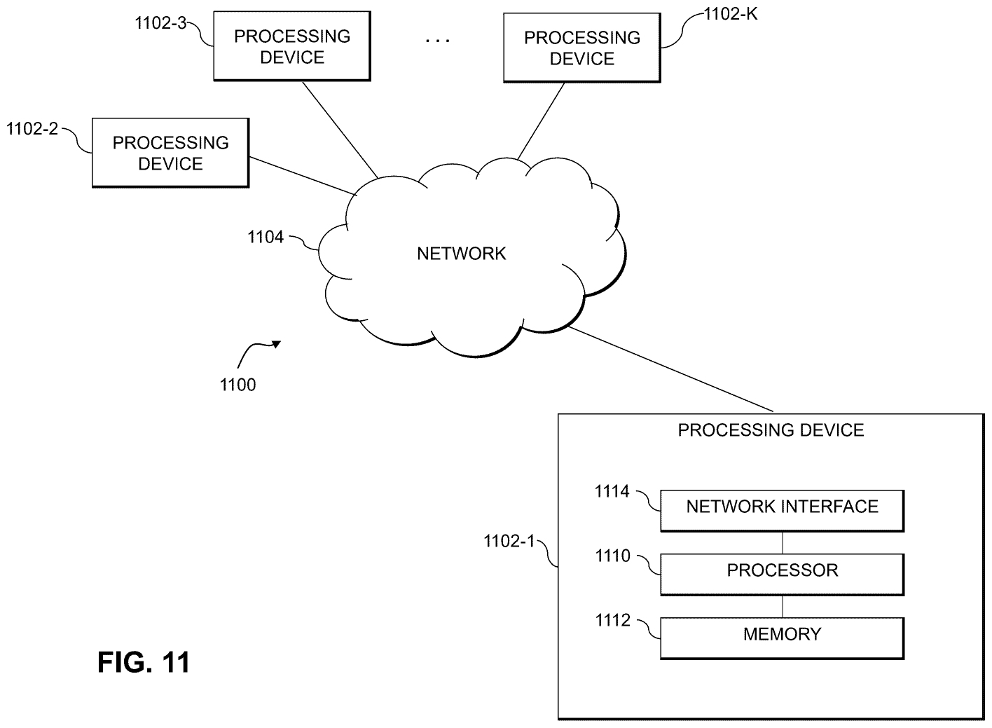

Additional examples of processing platforms utilized to implement portions of the system 100 in illustrative embodiments will be described in more detail below in conjunction with FIGS. 10 and 11.

It is to be understood that the particular set of elements shown in FIG. 1 for RL-based movement of containers using container power consumption information is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

For example, the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

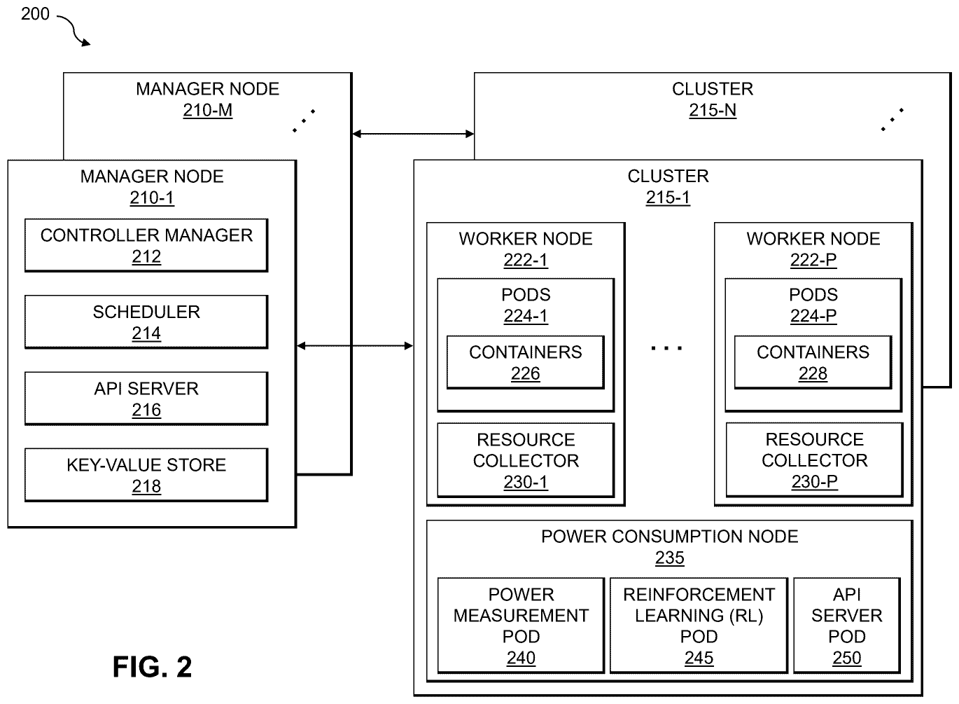

FIG. 2 depicts an example of a power-aware container movement environment 200 in an illustrative embodiment. In the example shown in FIG. 2, a plurality of manager nodes 210-1, . . . 210-M (herein each individually referred to as a manager node 210 or collectively as manager nodes 210) are operatively coupled to a plurality of clusters 215-1, . . . 215-N (herein each individually referred to as a cluster 215 or collectively as clusters 215). Each cluster 215 may be managed by at least one manager node 210.

As shown in FIG. 2, each manager node 210 comprises a controller manager 212, a scheduler 214, an API server 216, and a key-value store 218. It is to be appreciated that in some embodiments, multiple manager nodes 210 may share one or more of the same controller manager 212, scheduler 214, API server 216, and a key-value store 218.

Each cluster 215 comprises a plurality of worker nodes 222-1, . . . 222-P (herein each individually referred to as a worker node 222 or collectively as worker nodes 222). Each worker node 222 comprises one or more pods 224-1, . . . 224-P (herein each individually referred to as a pod 224 or collectively as pods 224), and a respective resource collector, i.e., one of a plurality of resource collectors 230-1, . . . 230-P (herein each individually referred to as a resource collector 230 or collectively as resource collectors 230). It is to be understood that one or more worker nodes 222 can run multiple pods 224 at a time. Each pod 224 comprises a set of one or more containers (e.g., containers 226 and 228). It is noted that each pod 224 may also have a different number of containers. As used herein, a pod may be referred to more generally as a containerized workload. Each resource collector 230 is configured to collect information (e.g., pertaining to resource utilization) related to its corresponding worker node 222, as explained in more detail elsewhere herein.

Worker nodes 222 of each cluster 215 execute one or more applications associated with pods 224 (e.g., containerized workloads). Each manager node 210 manages the worker nodes 222, and therefore pods 224 and containers, in its corresponding cluster 215 based at least in part on the information collected by its resource collectors 230. More particularly, each manager node 210 controls operations in its corresponding cluster 215 utilizing the above-mentioned components, e.g., controller manager 212, scheduler 214, API server 216, and key-value store 218, based at least in part on the information collected by the resource collectors 230. In general, controller manager 212 executes control processes (e.g., controllers) that are used to manage operations, for example, in the worker nodes 222. Scheduler 214 typically schedules containers to run on particular worker nodes 222 taking into account node resources, power consumption and application execution requirements such as, but not limited to, deadlines. In general, in a Kubernetes implementation, API server 216 exposes the Kubernetes API, which is the front end of the Kubernetes container orchestration system. Key-value store 218 typically provides key-value storage for all cluster data including, but not limited to, configuration data objects generated, modified, deleted, and otherwise managed, during the course of system operations.

The functionality associated with the elements 212, 214, 216, and/or 218 in other embodiments can also be combined into a single module, or separated across a larger number of modules. As another example, multiple distinct processors can be used to implement different ones of the elements 212, 214, 216, and/or 218 or portions thereof.

At least portions of elements 212, 214, 216, and/or 218 may be implemented at least in part in the form of software that is stored in memory and executed by a processor.

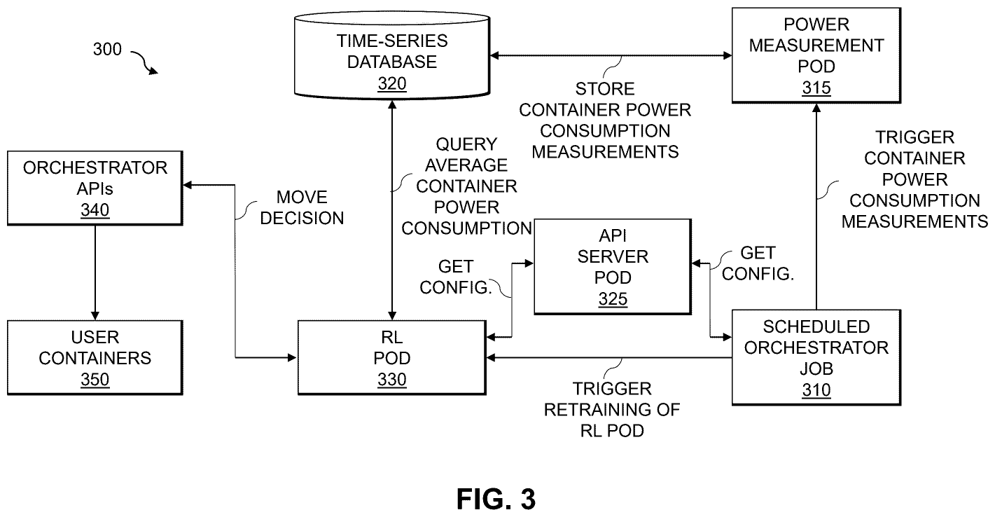

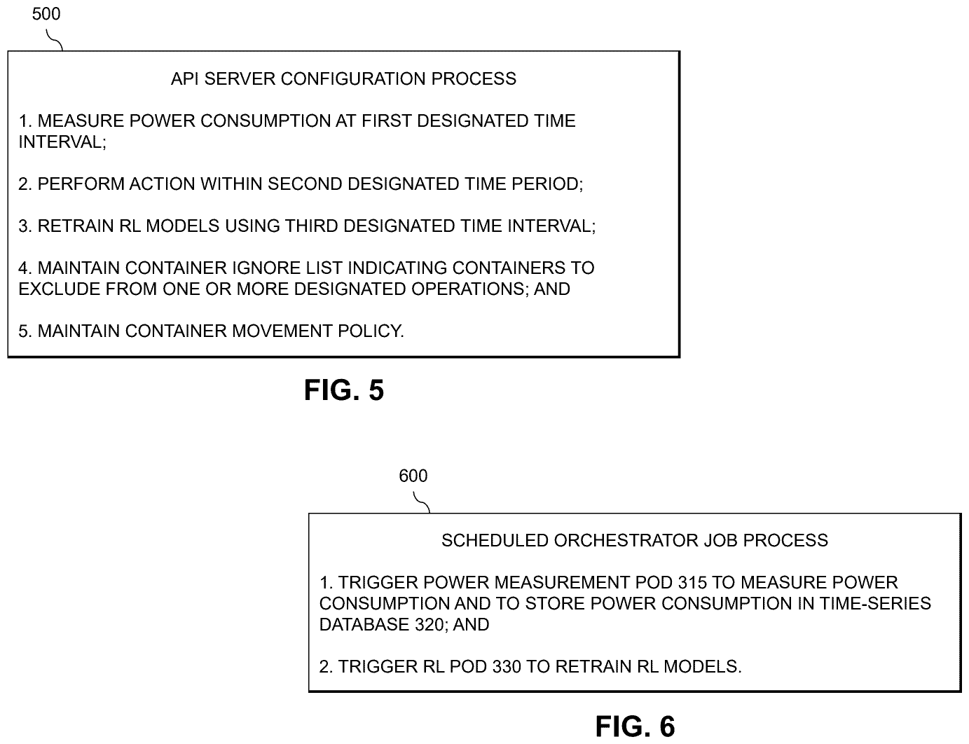

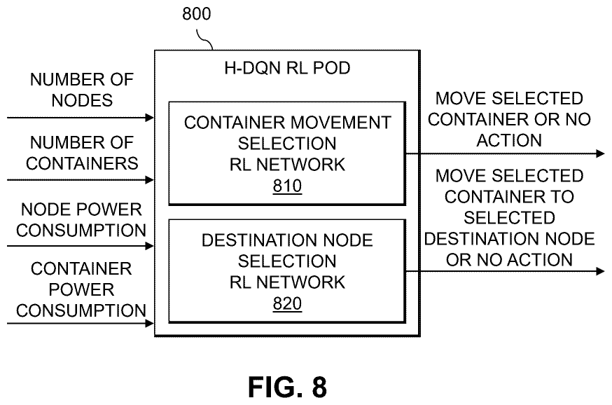

In the example of FIG. 2, each cluster 215 further comprises a power consumption node 235 that implements at least portions of the disclosed power-aware container movement techniques. The power consumption node 235 may be implemented as a dedicated node within a respective cluster 215 or as part of one or more worker nodes 222. The power consumption node 235 comprises a power measurement pod 240, a RL pod 245 and an API server pod 250. In at least some embodiments, the power measurement pod 240, the RL pod 245 and the API server pod 250 are implemented on a same node 222, 235 of the respective cluster 215. The power measurement pod 240 is discussed further below in conjunction with FIGS. 3 and 7, for example. The RL pod 245 is discussed further below in conjunction with FIGS. 3, 4 and 8, for example. The API server pod 250 is discussed further below in conjunction with FIGS. 3 and 5, for example.

FIG. 3 illustrates a system 300 for RL-based movement of containers using container power consumption information in an illustrative embodiment. In the example of FIG. 3, the system 300 comprises one or more scheduled orchestrator jobs 310, a power measurement pod 315, a time-series database 320, an API server pod 325, an RL pod 330, one or more orchestrator APIs 340 and one or more user containers 350.

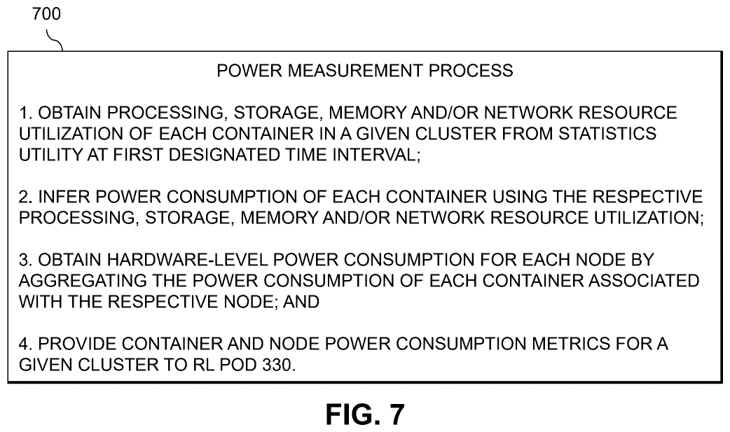

An exemplary scheduled orchestrator job 310 (e.g., that runs are at designated time interval) is discussed further below in conjunction with FIG. 6. A given scheduled orchestrator job 310 may trigger container power consumption measurements and store such power consumption measurements in the time-series database 320 and may also trigger a retraining of the RL pod 330. The power consumption data is inherently time-based, as it is measured and recorded at regular intervals. The scheduled orchestrator job 310 may also obtain configuration information from the API server pod 325, as discussed further below.

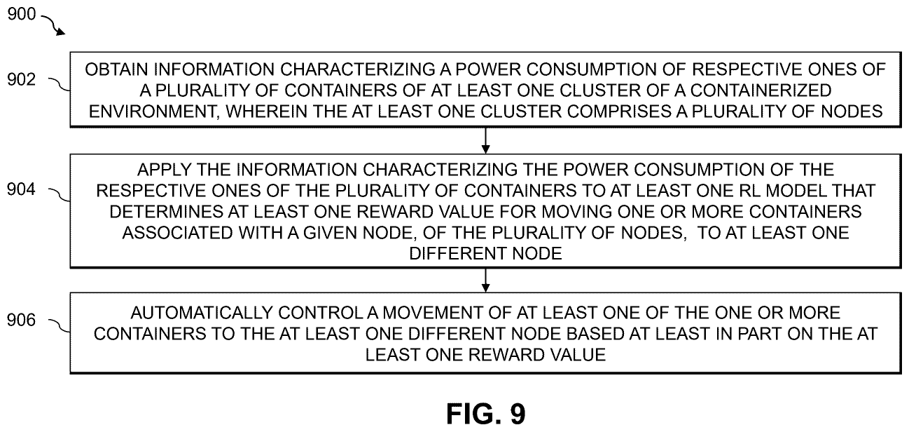

The RL pod 330 may query the time-series database to obtain average container power consumption values over time. In addition, the RL pod 330 may execute one or more RL models, as discussed further below in conjunction with FIG. 8, to obtain action recommendations (e.g., whether or not to move selected containers to selected nodes). When the RL pod 330 determines that one or more containers are to be moved to corresponding destination nodes, a move decision is sent to an orchestrator API 340 that implements the indicated movement of one or more user containers 350 to the respective indicated destination nodes. The RL pod 330 may also obtain configuration information from the API server pod 325, as discussed further below.

The API server pod 325 is discussed further below in conjunction with FIG. 5. For example, the API server pod 325 may measure container power consumption using a first designated time interval, perform indicated actions or tasks within a second designated time interval and retrain one or more RL models using a third designated time interval (e.g., every two weeks for rapidly changing environments and up to two months for slow-changing environments).

In one or more embodiments, the API server pod 325 may also interact with clients to create, update and/or delete configuration settings, including defining configuration values and managing associated configuration metadata. In addition, the API server pod 325 may also provide versioning capabilities, allowing clients to retrieve or revert to previous versions of a given configuration (e.g., for auditing, rollbacks and/or managing changes over time).

In some embodiments, the API server pod 325 may provide a mechanism to notify clients, for example, of configuration changes or events (for example, using webhooks, real-time messaging, or other mechanisms to ensure that applications stay up to date with configuration settings).

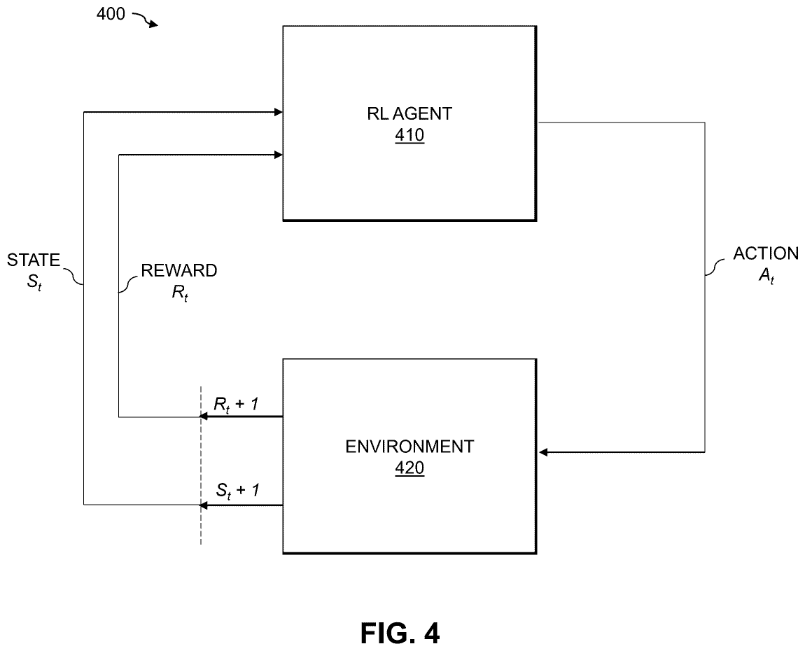

FIG. 4 illustrates an RL framework for RL-based movement of containers using container power consumption information in an illustrative embodiment. In the example of FIG. 4, a RL framework 400 includes a RL agent 410 and an environment 420 (e.g., a VM or other IT asset to which a container movement request is applied). As shown, the RL agent 410 receives or observes a state St at a time t. The RL agent 410 selects an action Aₜ based on its action selection policy, and transitions to a next state Sₜ₊₁ at a time t+1. The RL agent 410 receives a reward Rₜ₊₁ at a time t+1. The RL agent 410 may leverage an RL algorithm, which may include but is not limited to a Q-learning algorithm, a Deep Q Networks (DQN) algorithm, an H-DQN algorithm, a Double DQN (DDQN) algorithm, etc., to update an action-value function Q(Sᵢ,Aᵢ). An exemplary implementation using a pair of H-DQN RL networks is discussed further below in conjunction with FIG. 8. The action-value function defines a long-term value of taking an action Aᵢ in a state Sᵢ, as will be described in further detail below. Over time, the RL agent 410 learns to pursue actions that lead to the greatest cumulative reward at any state.

In some implementations, a Q-learning control algorithm is based on a Bellman Equation that predicts an expected response of the environment 420 using trial and error to learn. The Bellman Equation may be expressed, as follows:

$$Q ( S , A ) ← Q ( S , A ) + α ( R + γ {max}_{{a}^{′}} Q ( {S}^{′} , {a}^{′} ) - Q ( S , A ) ) ,$$

where, S is a particular state value, A is an action, S′ is a next state from state S by action A. R is a reward function, α is a learning step, that decides the speed and the variance of convergence, where α∈[0,1], and γ is a discount factor, that decides the importance of future reward, where γ∈[0,1]. Q(S,A) may be referred to as an action-value function that represents the expected return from a state S by an action A. If the learning step α is too large, it may result in a fast convergence but causes a large variance of convergence (e.g., providing more opportunities to choose a non-optimal action). If the learning step α is too small, it may result in a long time to learn the optimal actions. It can be shown that a learning step α of 0.1 is a good choice. A large value may be used for the discount factor, γ, such as γ=0.9, to make future and past states highly related.

A state space S includes a set of possible state values. A state Sₜ∈S is a vector of values from S={S₁, S₂, . . . , Sₙ} at time step t. In some embodiments, Sₜ comprises a given number of nodes, a given number of containers, information characterizing the power consumption of the nodes and information characterizing the power consumption of the containers. The RL agent 410, as noted above, observes the current state Sₜ at each time step t and takes an action Aₜ. An exemplary implementation using a pair of H-DQN RL networks is discussed further below in conjunction with FIG. 8. In some embodiments, the action Aₜ₁ associated with a first one of the H-DQN RL networks involves two possible alternative actions: initiating a movement of a selected container or no action. The action Aₜ₂ associated with a second one of the H-DQN RL networks involves two possible alternative actions: selecting a destination node for the selected container or no action.

FIG. 5 is a process diagram illustrating an API server configuration process 500 in an illustrative embodiment. In at least some embodiments, the API server configuration process 500 may be performed by the API server pod 325 of FIG. 3, for example. In the example of FIG. 5, the API server configuration process 500 initially configures the scheduled orchestrator job 310 in step 1 to trigger container power consumption measurements, by the power measurement pod 315, at a first designated time interval (e.g., every X minutes). In addition, the API server configuration process 500 configures the power-aware container movement system in step 2 to perform actions within a second designated time (e.g., a specific timeframe, such as Y minutes, within which the power-aware container movement system is expected to perform a certain action or complete a task, where a user configurable value of Y that represents a number of minutes allotted for a particular action).

The API server configuration process 500 configures the RL pod 330 in step 3 to retrain one or more RL models using a third designated time interval (e.g., every Z days).

A container ignore list is maintained in step 4 indicating one or more containers to exclude from one or more designated operations. The container ignore list may comprise a configuration and/or a list of rules that defines any containers that should be ignored or excluded from specific operations or processes within a container orchestration platform or system. For example, the container ignore list may be used for the following tasks:
to identify one or more containers to be excluded from default resource allocation rules, allowing them to have custom resource allocation settings or priorities.
to identify one or more containers to be excluded from default monitoring and alerting, where administrators configure default rules to monitor the health and performance of containers; and
to identify one or more containers to be excluded from autoscaling decisions that dynamically adjust a number of containers based on resource utilization or other metrics.

In container orchestrators, for example, the container ignore list can be implemented using configuration settings, annotations, or labels on containers, which are then referenced by monitoring tools, autoscaling controllers, or resource management policies to determine which containers should be ignored.

A container movement policy is maintained in step 4 that may be used to manage a movement or migration of one or more containers, applications and/or workloads within a cluster, for example, through pod rescheduling, node draining and/or workload redistribution. The container movement policy may address one or more of the following aspects:
Pod Rescheduling: orchestrator allows containers to be rescheduled automatically in case of node failures, evictions, or other disruptive events. A container movement policy may define rules for pod rescheduling, such as a maximum number of rescheduling allowed within a certain time interval, the priority of one or more containers to be rescheduled, or restrictions on rescheduling certain critical workloads.
Node Draining: when performing planned maintenance or decommissioning a node, it is often necessary to move containers from one node to other available nodes. The container movement policy can specify the process and guidelines for draining a node, which may involve evicting containers and rescheduling them onto other nodes, thereby ensuring a smooth transition and avoiding abrupt workload terminations.
Taints and Tolerations: an orchestrator may provide taint and toleration mechanisms to influence pod placement and scheduling decisions. Taints allow a given node to repel one or more pods. Tolerations allow the scheduler 215 to schedule pods with matching taints. A container movement policy may define specific taints to be applied to nodes that need to be drained or decommissioned and specify tolerations on containers that should be moved during a node draining process, thereby ensuring that the appropriate containers are relocated to other suitable nodes.
Pod Disruption Budgets (PDBs): PDBs may be used to control the number of pod disruptions that can occur simultaneously during planned or unplanned events. A container movement policy can define PDBs to restrict the number of containers that can be moved or disrupted at a given time, thereby ensuring an availability and stability of applications during the moving process.
Affinity and Anti-Affinity: an orchestrator may provide affinity and anti-affinity rules to influence pod placement based on, for example, node labels or other characteristics. A container movement policy can leverage these rules to specify the preferred or restricted locations for moving containers. For example, the container movement policy can ensure that certain containers are moved to nodes with specific resources or avoid moving containers together to the same node to enhance fault tolerance.
Monitoring and Verification: A container movement policy may include guidelines on monitoring the moving process and verifying the successful relocation of containers. The container movement policy can define metrics or indicators to be tracked during the move, such as pod readiness, resource allocation, or application health, to ensure that workloads are properly migrated and continue to function as expected.

FIG. 6 is a process diagram illustrating a scheduled orchestrator job process 600 in an illustrative embodiment. In at least some embodiments, the scheduled orchestrator job process 600 may correspond to the scheduled orchestrator job 310 of FIG. 3, for example. The scheduled orchestrator job process 600 may be scheduled using a job scheduler, such as the cron command-line utility, and may automatically restart failed jobs. A user may specify a time, date and frequency at which the job should run. The scheduled orchestrator job process 600 can be parallelized in some embodiments to run in multiple instances.

In the example of FIG. 6, the scheduled orchestrator job process 600 may trigger container power consumption measurements in step 1, by the power measurement pod 315 of FIG. 3, for example, at a first designated time interval (e.g., every X minutes), and to store the measured power consumption data in the time-series database 320 of FIG. 3. In step 2, the scheduled orchestrator job process 600 triggers the RL pod 330 of FIG. 3 to retrain one or more RL models using a third designated time interval (e.g., every Z days).

FIG. 7 is a process diagram illustrating a power measurement process 700 in an illustrative embodiment. In at least some embodiments, the power measurement process 700 may be implemented by the power measurement pod 315 of FIG. 3, for example. The power measurement process 700, in the example of FIG. 7, initially obtains processing, storage, memory and/or network resource utilization of each container in a given cluster in step 1 from a statistics utility at the first designated time interval (e.g., every X minutes). In step 2, a power consumption of each container is inferred using the respective processing, storage, memory and/or network resource utilization values, as discussed further below. A hardware-level power consumption is obtained in step 3 for each node by aggregating the power consumption of each container associated with the respective node (for example, when a given node is a separate server). The container and node power consumption metrics for a given cluster are provided in step 4 to the RL pod 330, as discussed further below in conjunction with FIG. 8.

The power consumption of each container may be inferred in step 2 using the respective processing, storage, memory and network resource utilization values using one or more of the following inference criteria:
mechanical components, such as hard disk drives (HDDs), in general, tend to consume more power relative to their non-mechanical counterparts, such as solid-state drives (SSDs);
HDDs rely on spinning disks and moving read/write heads to access and store data, which requires continuous power to keep them in motion (thus, HDDs consume more power during operation, leading to higher power consumption);
non-mechanical components, such as SSDs that use flash memory technology, can access and store data electronically without a need for physical motion, resulting in lower power consumption (thereby reducing power consumption and heat generation and improving overall system performance);
central processing units (CPUs) and/or graphical processing units (GPUs) often require a significant amount of power (e.g., primarily due to an extensive range of operations to be performed, where the magnitude of the heat being generated is directly related to the workload being carried out); and
an increase in processing utilization leads to a corresponding surge in power consumption, and the heat generated during computation needs to be dissipated (requiring additional power to regulate temperature through the implementation of cooling solutions).

The container resource utilization may be obtained, for example, from a resource monitoring utility that tracks computational and memory resources, for example, consumed by a container in real time. The resource monitoring utility can be scheduled to run at regular intervals, ensuring that resource consumption data is collected periodically, for example. In some embodiments, a statistics (“stats”) utility can be employed to track the individual resource utilization of each container (such as CPU utilization, memory utilization, network input/output (I/O) utilization, and block IO utilization). Weights may be employed to adjust the impact of a resource utilization value on a total power consumption (e.g., since not all components consume power at a same rate). In some embodiments, power consumption may be directly obtained from a separate power consumption tool. For rack servers and/or modular servers there may be additional components drawing power that need to be considered in determining the overall power consumption.

FIG. 8 illustrates an H-DQN RL pod 800 for power-aware container movement in an illustrative embodiment. In the example of FIG. 8, the H-DQN RL pod 800 comprises a container movement selection RL network 810 and a destination node selection RL network 820. The input values applied to the H-DQN RL pod 800 may comprise a number of nodes in a given cluster, a number of containers in the given cluster, a power consumption for each node in the given cluster and a power consumption for each container in the given cluster. If the given cluster does not have a certain container or node in its configuration, then the corresponding input value should be set to zero in the training data. The H-DQN RL pod 800 generates a Q value for each action, representing the expected cumulative reward for taking a particular action in a given state. The Q value for moving containers between nodes that do not exist on the given cluster should be zero.

As shown in FIG. 8, the container movement selection RL network 810 selects a given container to move and the corresponding action is to move a selected container or take no action. Likewise, the destination node selection RL network 820 selects a given destination node for a selected container to be moved and the corresponding action is to move a selected container to a selected destination node or take no action (e.g., when a given container is to be moved to the same node that the given container is already in).

In an implementation having, for example, 168 containers and 30 nodes in a given cluster, the output from the container movement selection RL network 810 would be a Q value for each of the 168 containers and the output from the destination node selection RL network 820 would be a Q value for each of the 30 nodes.

During a training of the RL models, multiple container types may be employed in the training data. The training data may comprise a power consumption for each node; a power consumption for each container, a container movement decision by the RL model and a reward (e.g., a power saving result after moving a container). The model performance may be measured in some embodiments in terms of, for example, total power saved per month.

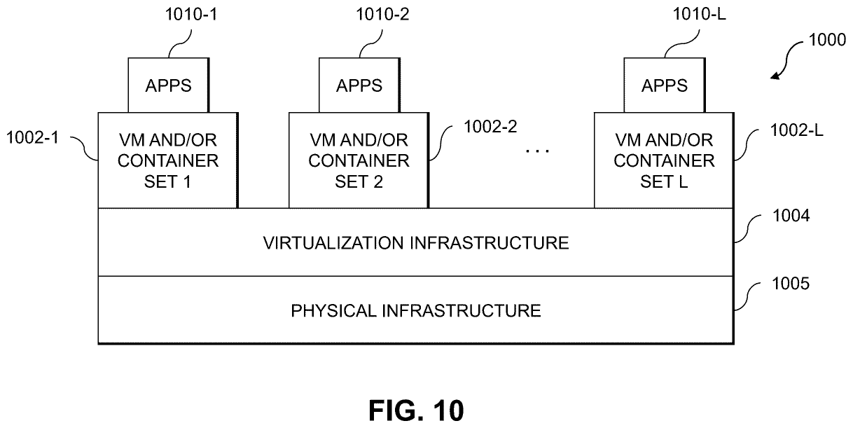

FIG. 9 is a flow diagram illustrating an exemplary implementation of a process 900 for RL-based movement of containers using container power consumption information in an illustrative embodiment. In the example of FIG. 9, the process 900 includes steps 902 through 906. These steps are assumed to be performed, for example, by the RL pod 245 of FIG. 2. The process begins at step 902, where information characterizing a power consumption of respective ones of a plurality of containers of at least one cluster of a containerized environment is obtained, wherein the at least one cluster comprises a plurality of nodes. In step 904, the information characterizing the power consumption of the respective ones of the plurality of containers is applied to at least one RL model (e.g., implemented using software that executes on one or more hardware devices) that determines at least one reward value for moving one or more containers associated with a given node, of the plurality of nodes, to at least one different node of the at least one cluster. A movement of at least one of the one or more containers to the at least one different node is automatically controlled in step 906 based at least in part on the at least one reward value.

In some embodiments, information is also obtained characterizing a power consumption of respective ones of the plurality of nodes of the at least one cluster of the containerized environment, and the information characterizing the power consumption of the respective ones of the plurality of nodes is applied to the at least one RL model that determines at least one second reward value for moving the one or more containers associated with the given node to the at least one different node of the at least one cluster. The at least one different node may be automatically selected based at least in part on the at least one second reward value.

In one or more embodiments, the power consumption of the respective ones of the plurality of containers is determined by evaluating a utilization of one or more resources of the respective ones of the plurality of containers for a designated time interval. The utilization of the one or more resources of the given container may comprise a utilization of at least one of a processing resource, a storage resource, a memory resource and a network resource. A power consumption of a given node may be determined by aggregating a power consumption of a plurality of containers associated with the given node.

In at least one embodiment, a retraining of the at least one RL model is initiated according to a designated schedule. The controlling the movement of the at least one container to the at least one different node may be performed in accordance with at least one designated container movement policy. The at least one RL model may comprise at least one container movement selection RL model and at least one destination node selection RL model.

The particular processing operations and other system functionality described in conjunction with the diagrams of FIGS. 3, 5 through 7 and 9 are presented by way of illustrative example only, and should not be construed as limiting the scope of the disclosure in any way. Alternative embodiments can use other types of processing operations for RL-based movement of containers using container power consumption information. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Advantageously, the techniques for RL-based movement of containers using container power consumption information described herein improve the power consumption of a containerized environment and reduce the amount of heat generated. In this manner, the disclosed power-aware container movement techniques help an organization to achieve sustainability and/or cost-efficiency.

In some embodiments, the disclosed techniques for RL-based movement of containers based on power consumption may be employed in a cellular environment. In cell towers, for example, the power consumption by servers within the cell towers can be inefficient. Such servers tend to remain operational even during intervals of low traffic, resulting in unnecessary power consumption and incurring significant costs for network providers. The disclosed power-aware container movement techniques can significantly reduce the power consumption and the amount of heat generated by such servers, without compromising network performance.

In one or more embodiments, one or more RL models may be employed to detect low network traffic conditions and to initiate power-aware server scheduling (e.g., within cell towers) to allow a distribution of operations. It has been observed that during off-peak hours, such as between 12 am and 8 am, server inactivity increases. By monitoring container utilization, power-aware scheduling during these hours can result in approximately a 50% reduction in power consumption. Containers may be rescheduled to different nodes, effectively reducing power consumption without compromising service quality. By allowing servers (or nodes) in cell towers to distribute load during periods of high activity, power consumption can be significantly reduced while maintaining servers in a state ready to respond to incoming requests.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for RL-based movement of containers based on power consumption will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple VMs and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a CPU, a GPU, a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for RL-based movement of containers using container power consumption information as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, container environments, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining information characterizing a power consumption of respective ones of a plurality of containers of at least one cluster of a containerized environment, wherein the at least one cluster comprises a plurality of nodes;
applying the information characterizing the power consumption of the respective ones of the plurality of containers to at least one reinforcement learning model that determines at least one reward value for moving one or more containers associated with a given node, of the plurality of nodes, to at least one different node of the at least one cluster; and
automatically controlling a movement of at least one of the one or more containers to the at least one different node based at least in part on the at least one reward value;
wherein the method is performed by at least one processing device comprising a processor coupled to a memory.

2. The method of claim 1, further comprising:
obtaining information characterizing a power consumption of respective ones of the plurality of nodes of the at least one cluster of the containerized environment;
applying the information characterizing the power consumption of the respective ones of the plurality of nodes to the at least one reinforcement learning model that determines at least one second reward value for moving the one or more containers associated with the given node to the at least one different node of the at least one cluster; and
automatically selecting the at least one different node based at least in part on the at least one second reward value.

3. The method of claim 1, wherein the power consumption of the respective ones of the plurality of containers is determined by evaluating a utilization of one or more resources of the respective ones of the plurality of containers for a designated time interval.

4. The method of claim 3, wherein the utilization of the one or more resources of the given container comprises a utilization of at least one of a processing resource, a storage resource, a memory resource and a network resource.

5. The method of claim 3, further comprising determining a power consumption of a given node by aggregating a power consumption of a plurality of containers associated with the given node.

6. The method of claim 1, further comprising initiating a retraining of the at least one reinforcement learning model according to a designated schedule.

7. The method of claim 1, wherein the controlling the movement of the at least one container to the at least one different node is performed in accordance with at least one designated container movement policy.

8. The method of claim 1, wherein the at least one reinforcement learning model comprises at least one container movement selection reinforcement learning model and at least one destination node selection reinforcement learning model.

9. An apparatus comprising:
at least one processing device comprising a processor coupled to a memory;
the at least one processing device being configured to implement the following steps:
obtaining information characterizing a power consumption of respective ones of a plurality of containers of at least one cluster of a containerized environment, wherein the at least one cluster comprises a plurality of nodes;
applying the information characterizing the power consumption of the respective ones of the plurality of containers to at least one reinforcement learning model that determines at least one reward value for moving one or more containers associated with a given node, of the plurality of nodes, to at least one different node of the at least one cluster; and
automatically controlling a movement of at least one of the one or more containers to the at least one different node based at least in part on the at least one reward value.

10. The apparatus of claim 9, further comprising:
obtaining information characterizing a power consumption of respective ones of the plurality of nodes of the at least one cluster of the containerized environment;
applying the information characterizing the power consumption of the respective ones of the plurality of nodes to the at least one reinforcement learning model that determines at least one second reward value for moving the one or more containers associated with the given node to the at least one different node of the at least one cluster; and
automatically selecting the at least one different node based at least in part on the at least one second reward value.

11. The apparatus of claim 9, wherein the power consumption of the respective ones of the plurality of containers is determined by evaluating a utilization of one or more resources of the respective ones of the plurality of containers for a designated time interval.

12. The apparatus of claim 9, further comprising initiating a retraining of the at least one reinforcement learning model according to a designated schedule.

13. The apparatus of claim 9, wherein the controlling the movement of the at least one container to the at least one different node is performed in accordance with at least one designated container movement policy.

14. The apparatus of claim 9, wherein the at least one reinforcement learning model comprises at least one container movement selection reinforcement learning model and at least one destination node selection reinforcement learning model.

15. A non-transitory processor-readable storage medium having stored therein program code of one or more software programs, wherein the program code when executed by at least one processing device causes the at least one processing device to perform the following steps:
obtaining information characterizing a power consumption of respective ones of a plurality of containers of at least one cluster of a containerized environment, wherein the at least one cluster comprises a plurality of nodes;
applying the information characterizing the power consumption of the respective ones of the plurality of containers to at least one reinforcement learning model that determines at least one reward value for moving one or more containers associated with a given node, of the plurality of nodes, to at least one different node of the at least one cluster; and
automatically controlling a movement of at least one of the one or more containers to the at least one different node based at least in part on the at least one reward value.

16. The non-transitory processor-readable storage medium of claim 15, further comprising:
obtaining information characterizing a power consumption of respective ones of the plurality of nodes of the at least one cluster of the containerized environment;
applying the information characterizing the power consumption of the respective ones of the plurality of nodes to the at least one reinforcement learning model that determines at least one second reward value for moving the one or more containers associated with the given node to the at least one different node of the at least one cluster; and
automatically selecting the at least one different node based at least in part on the at least one second reward value.

17. The non-transitory processor-readable storage medium of claim 15, wherein the power consumption of the respective ones of the plurality of containers is determined by evaluating a utilization of one or more resources of the respective ones of the plurality of containers for a designated time interval.

18. The non-transitory processor-readable storage medium of claim 15, further comprising initiating a retraining of the at least one reinforcement learning model according to a designated schedule.

19. The non-transitory processor-readable storage medium of claim 15, wherein the controlling the movement of the at least one container to the at least one different node is performed in accordance with at least one designated container movement policy.

20. The non-transitory processor-readable storage medium of claim 15, wherein the at least one reinforcement learning model comprises at least one container movement selection reinforcement learning model and at least one destination node selection reinforcement learning model.
